(19) United States
(12) Patent Application Publication
(10) Pub. No.: US 2012/0066906 A1
(43) Pub. Date: Mar. 22, 2012

(54) ASSEMBLY FACILITATION APPARATUS AND METHOD

(76) Inventor: BERND P. DAESCHNER, Fairview, PA (US)

(21) Appl. No.: 12/885,624

(22) Filed: Sep. 20, 2010

(51) Int. Cl. B23P 11/00; B23P 15/14; B25B 27/14

(52) U.S. Cl. 29/893.1; 29/824; 29/267

(57) ABSTRACT

An assembly apparatus that includes a frame and a load plate operatively connected to the frame. The load plate is configured to support a workpiece and is selectively extendable from a first position in which at least a portion of the load plate is positioned over the frame, to a second position in which the load plate is extended from the frame such that the workpiece is transferable from the load plate to a sub-assembly.

### FIELD OF THE INVENTION

Embodiments of the invention relate generally to an assembly facilitation apparatus and method and, in particular, to an apparatus for installing gears into an input carrier.

### BACKGROUND OF THE INVENTION

Wind turbine systems are conventionally known. Such systems generally include a rotor head to which wind turbine blades are attached, a main shaft coupled to the rotor head so as to integrally rotate with the rotor head, a gear box coupled to the main shaft that rotates by means of wind power received by the wind turbine blades, and an electrical generator driven by an output shaft from the gear box. The gearbox and generator are typically housed in a nacelle mounted atop a tower.

In use, the wind turbine blades transform wind energy into a rotational torque or force that drives the electrical generator. The gearbox is used to step up the inherently slow rotation, high torque of the turbine rotor to a much higher rotation and lower torque for input into the electrical generator. In this manner, the gearbox provides a high speed, low torque output to the generator suitable for the production of electricity.

Conventional gear boxes for use with wind turbines can weigh several tons and typically contain numerous stages and gears to achieve an overall gear ratio from 40:1 to over 100:1, depending on the size of the turbine. As will be readily appreciated, assembling such large and heavy components found in wind turbine gearboxes presents several problems. In particular, transferring a relatively heavy and cumbersome carrier gear from a workstation to a subassembly, such as an input carrier, and installing the gears therein, has proven difficult and time consuming. Accordingly, there is a need for an apparatus that facilitates the assembly of gearbox components to an extent heretofore unknown. In addition, there is a need for a method of installing gears into an input carrier that is easier and more efficient than known methods.

### BRIEF DESCRIPTION OF THE INVENTION

According to one embodiment of the present invention, an assembly apparatus includes a frame and a load plate operatively connected to the frame. The load plate is configured to support a workpiece such as a carrier gear and is selectively extendable from a first position in which at least a portion of the load plate is positioned over the frame, to a second position in which the load plate is extended from the frame such that the workpiece is transferable from the load plate to a subassembly.

According to another embodiment of the present invention, an apparatus for facilitating the assembly of a carrier gear into an input carrier of a gear box and includes a frame including wheels, a braking mechanism to prevent rotation of the wheels, and a handle, a load plate operatively connected to the frame via a plurality of height adjustable legs and a lever arm operatively secured to the frame. The lever arm is selectively actuatable to move the load plate from a first position, in which the load plate is positioned at least in part over the frame, to a second position in which the load plate is extended from the frame such that a carrier gear supported by the load plate is transferrable from the frame to a space defined by an input carrier.

Yet another embodiment of the inventive apparatus is a method of assembling a gearbox. The method includes moving an assembly apparatus that is supporting a gear proximate to a gear carrier which defines one or more gear receptacles, extending the gear toward the gear carrier while the assembly apparatus is supporting the gear, and levering the gear from the assembly apparatus into the gear receptacle of the gear carrier.

### BRIEF DESCRIPTION OF THE DRAWINGS

The present invention will be better understood from reading the following description of non-limiting embodiments, with reference to the attached drawings, wherein below:

FIG. 1 is an isometric view of a lower frame and base portion of an assembly apparatus in accordance with an embodiment of the inventive apparatus for assembling a carrier gear of a gear box.

FIG. 2 is a side elevational view of the lower frame and base portion of the assembly apparatus of FIG. 1.

FIG. 3 is an isometric view of an upper frame portion and load plate of the assembly apparatus for assembling a carrier gear of a gear box.

FIG. 4 is a side elevational view of the upper frame portion and load plate of the assembly apparatus of FIG. 3.

FIG. 5 is a top plan view of the assembly apparatus in accordance with an embodiment of the inventive apparatus for assembling a carrier gear of a gear box.

FIG. 6 is an isometric view of a lever arm of the assembly apparatus in accordance with an embodiment of the inventive apparatus for assembling a carrier gear of a gear box.

FIG. 7 is an isometric view of an upper portion of the assembly apparatus of the present invention in operation and illustrating the transfer of a gear from the assembly apparatus to a subassembly.

### DETAILED DESCRIPTION OF THE INVENTION

Reference will be made below in detail to exemplary embodiments of the invention, examples of which are illustrated in the accompanying drawings. Wherever possible, the same reference numerals used throughout the drawings refer to the same or like parts.

As described in detail below, an embodiment of the present invention provides an apparatus that slides an input carrier gear into an input carrier and which facilitates the assembly of a gearbox for use in wind turbine power generation systems. Embodiments of the inventive apparatus include beneficial alignment, transfer and transportation/motive features.

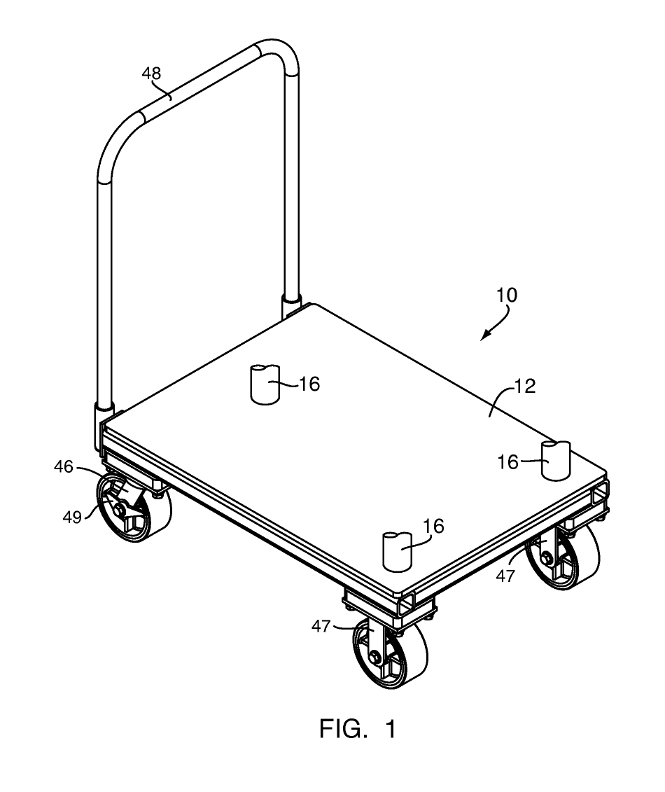

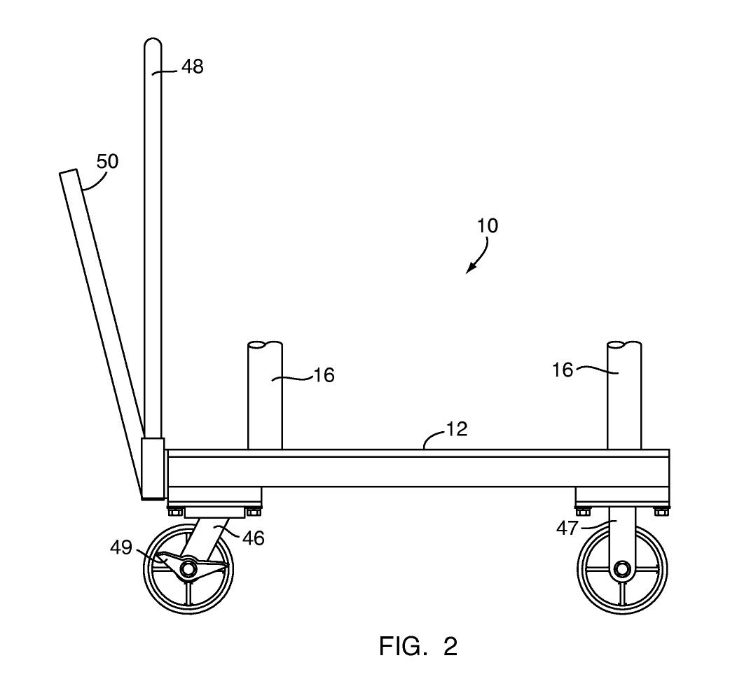

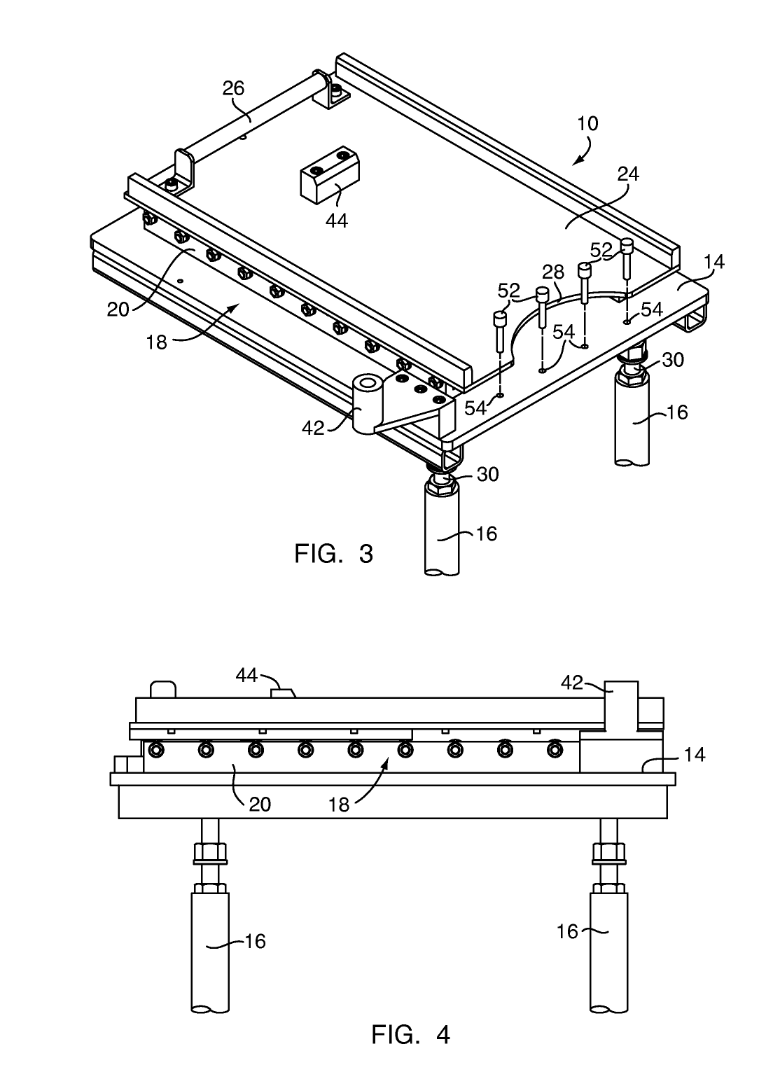

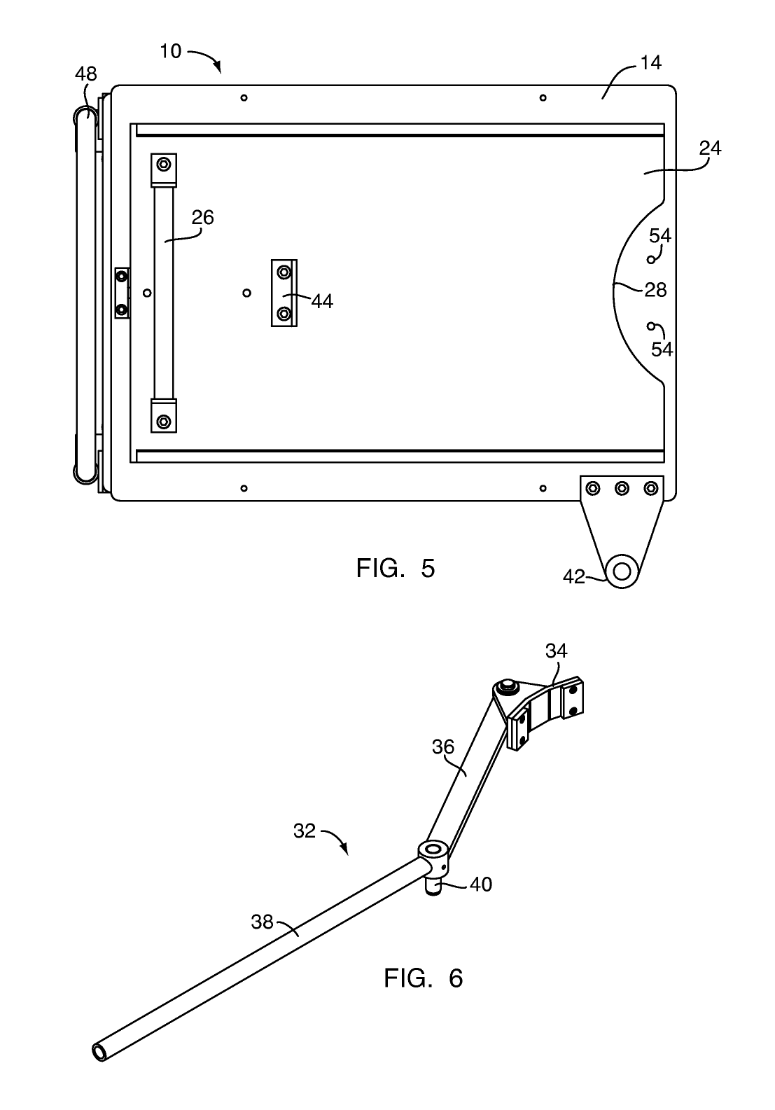

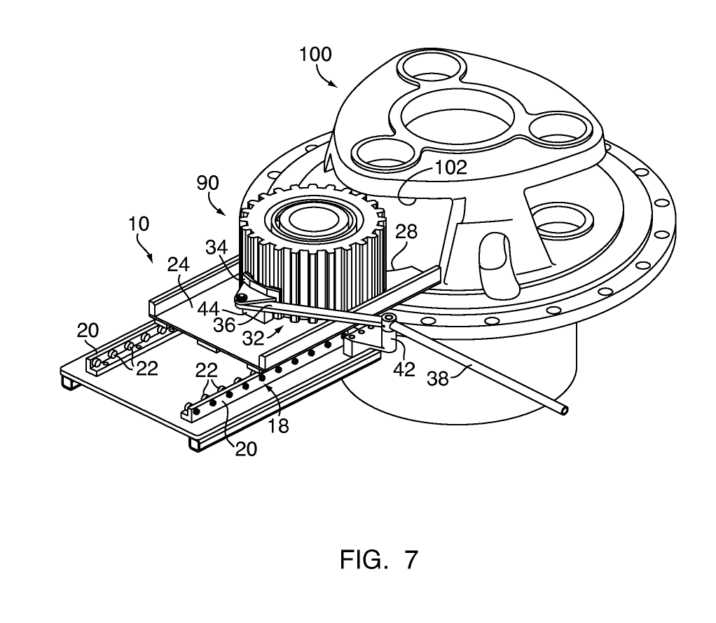

Referring generally to FIGS. 1-7, an embodiment of the assembly apparatus 10 of the present invention generally takes the form of a gear cart. The cart 10 includes a lower frame portion 12 and an upper frame portion 14, the upper frame portion 14 being positioned directly above the lower frame portion 12. The upper and lower frame portions 12, 14 are generally rectangular in shape, however other frame configurations are possible. A plurality of height-adjustable legs connect 16 the lower frame portion 12 to the upper frame portion 14. As best shown in FIGS. 1 and 3, there are three legs, two positioned adjacent the leading edge of the cart and one at the trailing edge, although more than three legs may be used for added support of the upper frame portion 14.

A roller assembly 18 is secured to an upper surface of the upper frame portion 14 for facilitating the transfer of a workpiece 90 from the assembly apparatus 10 to a subassembly 100, as discussed in detail below. The roller assembly 18 includes a plurality of rails 20 that extend from the trailing edge of the assembly 10 to the leading edge of the assembly 10, and a plurality of rollers 22 operatively secured to the rails 20. A load plate 24 is operatively connected to the roller assembly 18 and is configured to support the workpiece 90.

The load plate 24 is selectively extendable via its rolling engagement with the roller assembly 18 from a first position, in which a majority of the load plate 24 is positioned directly over the upper frame portion 14, to a second position, in which the load plate 24 is extended from the upper frame portion 14 to traverse a distance to a subassembly 100 such that the workpiece 90 may be transferred from the load plate 24 to the subassembly 100. A handle or bar 26 may be attached to the load plate for allowing a user to effectuate movement of the load plate 24 along the roller assembly 18 from the first position to the second position, and vice versa.

The load plate 24 has a lip 28 for engaging a surface of the subassembly 100 to facilitate transfer of the workpiece 90 from the load plate 24 to the subassembly 100. In the case where the workpiece 90 is a carrier gear and the subassembly 100 is an input carrier, the input carrier may have a curved profile (i.e., the shape of part of the input carrier, in profile, is curved) and the load plate may have a contoured lip configured to matingly engage the curved profile of the input carrier. The load plate 24 may also be operable to tilt to facilitate transfer of the workpiece 90 from the assembly apparatus 10 to the subassembly 100.

In particular, as alluded to above, each of the legs 16 may be configured with a hydraulic press or cylinder 30. Each hydraulic press 30 may be actuated independently or concurrently with the other hydraulic presses. For example, to adjust the height of the load plate 24 above the floor, each hydraulic press may 30 be actuated simultaneously to increase the height of the legs 16, and thus the height of the load plate 24 relative to the subassembly 100. To tilt the load plate 24, however, only the hydraulic press associated with the rear leg or legs is actuated, thereby increasing the height of the rearward portion of the load plate 24 relative to the subassembly 100. Thus, the load plate 24 may be tilted (e.g., using hydraulic force), without removing the wheels from the ground or support surface, to facilitate transfer of the carrier gear from the load plate to the input carrier.

The assembly apparatus 10 of the present invention further includes a lever arm 32 removably secured to the upper frame portion 14. It will be readily appreciated, however, that the lever arm 32 may be fixedly secured to the frame. The lever arm 32 has an engagement portion 34 for engaging a workpiece, such as a carrier gear, a first leg 36 extending from the engagement portion 34 at a first angle, and a second leg 38 extending from the first leg 36 at a second angle. A locating shaft 40 extends downwardly from the connection point between the first leg 36 and the second leg 38 and is received in a corresponding sleeve 42 mounted to the upper frame portion 14. The sleeve 42 acts as a fulcrum about which the lever arm 32 pivots. When mounted on the upper frame portion 14 of the cart 10, the lever arm 32 is prevented from moving rearward relative to the load plate 24 by a block 44 fixedly attached to an upper surface of the load plate 24. The lever arm 32 is operable to urge the workpiece 90 from the load plate 24 to a received configuration on the subassembly 100, with at least a 3-to-1 advantage, as discussed below.

In addition to the above, the cart 10 may be fitted with a plurality of wheels (for example, swivel casters) for supporting the cart 10 and for facilitating movement thereof. The wheels may be attached to an underside of the lower frame portion 12 by bolts or other means known in the art. In particular, there may be two swivel casters 46 and two rigid casters 47, although other configurations, such as four swivel casters may also be employed. A braking mechanism 49 may be coupled to at least one of the plurality of wheels to enable a user to lock the apparatus 10 in place such that it will not roll or move from its set location. In particular, the braking mechanism prevents rotation of the wheels so as to lock the cart 10 in place. As with the wheels/swivel casters 46, 47, the braking mechanism 49 may be fixedly attached to the underside of the lower frame portion 12 by bolts or other means known in the art. The cart 10 is also provided with a transport handle 48 that extends from the lower frame portion 12, in the shape of an inverted U, to a height sufficient to enable a user to comfortably navigate the cart 10 from location to location.

The assembly apparatus 10 may also include an attachment mechanism, such as a tongue hitch 50 pivotally attached to the cart 10 at, for example, the lower frame portion 12. The attachment mechanism allows the apparatus to be secured to motive power or to another assembly apparatus or cart.

In operation, a carrier gear or other workpiece 90 may be placed on a forward portion of the load plate 24. In this position, operators may work on the workpiece 90, e.g., a carrier gear, and install additional components. In this respect, all assembly work can be done on the cart 10. After the assembly work on the carrier gear is completed, the cart 10 and carrier gear are wheeled to a subassembly 100, such as input carrier, for installation of the carrier gear. The cart 10 is positioned so that carrier gear 90 is supported proximate the gear/input carrier 100 defining one or more gear receptacles 102 such that the lip 28 of the load plate 24 engages a surface of the input carrier 100. Once the assembly apparatus 10 is in place, the wheels 46 may be locked to prevent movement of the apparatus 10. The load plate 24 is then extended toward the gear carrier 100, from a first position to a second position, by rolling the load plate 24 along the roller assembly 18. The lever arm 32 is then used to urge the carrier gear 90 from the assembly apparatus 10 and into the gear receptacle 102 of the gear carrier/input carrier 100. As will be readily appreciated, the assembly apparatus 10 of the present invention allows for the transport of the carrier gear to the carrier input, rather than the carrier input to the carrier gear.

In order to securely connect the apparatus 10 to the input carrier 100, an embodiment of the present invention further includes a fastener 52, and the frame 14, the load plate 24, a subassembly support, or a combination of two or more of the foregoing have a surface that defines at least one aperture 54 configured to receive the fastener 52 to selectively lock the frame and cart 10 in a determined orientation relative to the subassembly 100 to further facilitate transfer of the workpiece 90.

The legs 16 of the apparatus may be raised or lower via the hydraulic cylinders 30 to properly align the gear 90 with the input carrier 100, as noted above. In addition, to facilitate transfer of the gear 90 from the load plate 24 to the input carrier 90, the rear hydraulic cylinder can be actuated to tilt the load plate 24 towards the input carrier 100. Moreover, the load plate 24 may be manufactured with a coating having a low coefficient of friction, or a surface treatment, to reduce the friction between the load plate and the carrier gear, thereby facilitating transfer of the carrier gear off of the load plate.

Sensors can also be configured on the apparatus to communicate with an overall tracking system that can correlate field problems back to end play check measurements to look for and/or predict failures. In addition, it is contemplated that robotics can be used to actuate the lever arm. Moreover, a roller or belt system can be operatively attached to the load plate to move the gear forward into the input carrier, and a sensor may be used to precisely align the gear in the input carrier.

An embodiment of the inventive apparatus may include a frame and a load plate connected to the frame and configured to support a workpiece, wherein the load plate is selectively extendable from a first position in which at least a portion of the load plate is positioned over the frame, to a second position in which the load plate is extended from the frame such that the workpiece is transferrable form the load plate to the sub-assembly. In other embodiments the apparatus may include, in addition to the above, a lever arm secured to the frame that is operable to urge the workpiece form the load plate to the sub-assembly.

The apparatus may also include a plurality of wheels supporting the frame and a braking mechanism coupled at least one of the wheels. In yet other embodiments, the frame may have a plurality of legs that, in certain circumstances, may be height adjustable. At least one hydraulic lift may be included in certain embodiments to raise or lower the load plate.

In yet other embodiments, the load plate may include a lip that engages a surface of the sub-assembly to facilitate transfer of the workpiece, and the load plate may be configured to tilt to also facilitate such transfer. Additionally, the frame may include at least one rail and a plurality of rollers secured thereto whereby the rollers facilitate extension of the load plate from the first position to the second position.

In other embodiments, the apparatus may include a coating to reduce friction between the load plate and the workpiece, an attachment mechanism to attach the frame to motive power or another assembly apparatus, and/or a fastening means to selectively lock the frame in a determined orientation relative to the sub-assembly.

In addition to the above, an embodiment of the present invention contemplates a method of assembling a gearbox. The method includes the steps of moving an assembly apparatus that is supporting a gear proximate to a carrier gear, extending the gear toward the gear carrier while the assembly apparatus is supporting the workpiece, and levering the gear from the assembly apparatus into the gear receptacle of the gear carrier. (In one aspect, “proximate” means close enough so that when the gear is extended, it can be levered from the assembly apparatus into the gear receptacle.) The method may additionally include the step of securing the assembly apparatus in a determined position relative to the gear carrier prior to levering the gear.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled.

In the appended claims, the terms “including” and “in which” are used as the plain-English equivalents of the respective terms “comprising” and “wherein.” Moreover, in the following claims, the terms “first,” “second,” “third,” “upper,” “lower,” “bottom,” “top,” “up,” “down,” etc. are used merely as labels, and are not intended to impose numerical or positional requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the invention, including the best mode, and also to enable any person skilled in the art to practice the embodiments of invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described embodiments, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. An assembly apparatus, the apparatus comprising:
a frame;
a load plate operatively connected to the frame, the load plate configured to support a workpiece; and
wherein the load plate is selectively extendable from a first position in which at least a portion of the load plate is positioned over the frame, to a second position in which the load plate is extended from the frame such that the workpiece is transferable from the load plate to a sub-assembly.

2. The assembly apparatus of claim 1, further comprising a lever arm secured to the frame, and the lever arm operable to urge the workpiece from the load plate to the sub-assembly.

3. The assembly apparatus of claim 1, further comprising a plurality of wheels supporting the frame.

4. The assembly apparatus of claim 3, further comprising a braking mechanism coupled to at least one of the plurality of wheels.

5. The assembly apparatus of claim 1, wherein the frame includes a plurality of legs, the legs supporting the load plate.

6. The assembly apparatus of claim 5, wherein the legs are adjustable in height.

7. The assembly apparatus of claim 5, further comprising at least one hydraulic lift operable to raise or lower the load plate.

8. The assembly apparatus of claim 1, wherein the load plate has a lip, and the lip engages a surface of the sub-assembly to facilitate the transfer of the workpiece to the sub-assembly.

9. The assembly apparatus of claim 1, wherein the load plate is operable to tilt to facilitate transfer of the workpiece from the load plate to the sub-assembly.

10. The assembly apparatus of claim 1, wherein the frame includes an attachment mechanism to attach the frame to motive power or to another assembly apparatus.

11. The assembly apparatus of claim 1, wherein the frame further comprises:
at least one rail; and
a plurality of rollers operatively secured to the at least one rail, and wherein the rollers facilitate extension of the load plate from the first position to the second position.

12. The assembly apparatus of claim 1, further comprising a fastener, and the frame, the load plate, a sub-assembly support, or a combination of two or more of the foregoing have a surface that defines at least one aperture configured to receive the fastener to reversibly lock the frame in a determined orientation relative to the sub-assembly, thereby to facilitate transfer of the workpiece to the sub-assembly.

13. The assembly apparatus of claim 1, further comprising a coating to reduce friction between the load plate and the workpiece.

14. An apparatus for assembling a carrier gear of a gear box, the apparatus comprising:
a frame, the frame including a plurality of wheels, a braking mechanism to prevent rotation of the wheels, and a handle;
a load plate operatively connected to the frame via a plurality of height adjustable legs, the load plate supporting a carrier gear;
a lever arm operatively secured to the frame; and
the lever arm is selectively actuatable to move the load plate from a first position, in which the load plate is positioned at least in part over the frame, to a second position in which the load plate is extended from the frame such that the carrier gear is transferable from the frame to a space defined by an input carrier.

15. The apparatus of claim 14, wherein the input carrier has a curved profile, and the load plate has a lip contoured to matingly engage said the curved profile of input carrier, thereby facilitating transfer and attachment of the carrier gear to the input carrier.

16. The apparatus of claim 14, wherein the load plate is configured to be tilted, without removing the wheels from a ground or support surface, to facilitate transfer of the carrier gear from the load plate to the input carrier.

17. The apparatus of claim 14, wherein the frame further comprises:
at least one rail;
a plurality of rollers operatively secured to the at least one rail; and
wherein the rollers facilitate extension of the load plate from the first position to the second position.

18. The apparatus of claim 14, wherein the frame includes at least one aperture configured to receive a fastener so that the apparatus may be connected to the input carrier to facilitate transfer of the carrier gear to the sub-assembly.

19. A method of assembling a gearbox, the method comprising the steps of:
moving an assembly apparatus that is supporting a gear proximate to a gear carrier, which defines one or more gear receptacles;
extending the gear toward the gear carrier while the assembly apparatus is supporting the workpiece; and
levering the gear from the assembly apparatus into the gear receptacle of the gear carrier.

20. The method of claim 19, further comprising the step of:
securing the assembly apparatus in a determined position relative to the gear carrier prior to levering the gear.
